(19) United States
(12) Patent Application Publication
(10) Pub. No.: US 2006/0264324 A1
(43) Pub. Date: Nov. 23, 2006

(54) Materials encapsulated in porous matrices for the reversible storage of hydrogen

(76) Inventors: Ferdi Schuth, Mulheim an der Ruhr (DE); Borislav Bogdanovic, Mulheim an der Ruhr (DE); Taguchi Akira, Kounosu-City (JP)

Correspondence Address: NORRIS, MCLAUGHLIN & MARCUS, P.A., 875 THIRD AVE, 18TH FLOOR, NEW YORK, NY, 10022, US

(21) Appl. No.: 10/564,291

(22) PCT Filed: Jul. 8, 2004
(86) PCT No.: PCT/EP04/07496

§ 371 Date: Jul. 26, 2006

(30) Foreign Application Priority Data
Jul. 16, 2003 (DE) 103 32 438.0

(51) Int. Cl. B01J 20/00

(52) U.S. Cl. 502/400; 502/414; 420/900

(57) ABSTRACT

High dispersion of hydrogen storage material comprising a component suitable for hydrogen storage purposes selected from alkali alanate, a mixture of aluminum metal with alkali metal and/or alkali metal hydride and magnesium hydride or mixtures thereof, wherein the hydrogen storage component is encapsulated in a porous matrix.

High dispersion of hydrogen storage material can be achieved by encapsulating the material in highly porous solid matrices.

Suitable means for hydrogen storage are one of the key requirements for hydrogen fuel cell technology (State-of-the-art review on hydrogen storage is presented in a special issue of the Materials Research Society Bulletin, September 2002). Physical methods, such as compression or liquefaction, are viable solutions, but they have severe disadvantages, such as the need for high pressures in order to achieve sufficiently high storage densities, or the need for cryogenic systems to overcome evaporation losses.

An alternative is storing hydrogen in the form of hydrides. However, not many hydrides are suitable for this, due to either too high or too low decomposition temperatures, insufficient gravimetric of volumetric storage capacity, or irreversibility of hydrogen release. It was therefore considered a very significant invention that NaAlH₄ can be used as a reversible hydrogen storage material (Equations 1a,b), alone and especially when doped with transition or rare earth metal catalysts, in particular titanium (WO97/03919, WO01/02363 and DE 101 63697).

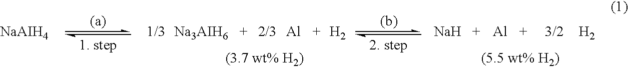

However, at present, these materials still have several shortcomings, among them especially
the kinetics of hydrogen dis- and recharging needs to be further improved; this is especially valid for the recharging rate, which should be in the order of several minutes;
safety aspects, due to the pyrophoric nature of doped alanates, are not yet solved;
thermodynamic properties of doped alanates have to be adjusted to the requirements given by the temperature of the waste heat of fuel cell cars (˜100° C.).

Object of present invention was to overcome the disadvantages of the hydrogen storage materials of the state of art.

Subject of present invention is a material, comprising a component suitable for hydrogen storage purposes selected from alkali alanate, a mixture of aluminum metal with alkali metal and/or alkali metal hydride and magnesium hydride or mixtures thereof, characterized in that the hydrogen storage component is encapsulated in a porous matrix.

Surprisingly, it has now been found that these problems can be partially or largely obviated, if the storage material is dispersed inside of very small compartments (encapsulation), which are present in many kinds of materials, i.e. highly porous materials.

Porous matrix materials suitable for the purposes of present invention are all porous organic or inorganic materials that do not have any destabilizing effects on the hydrogen storage component. Particularly suitable for encapsulation, especially of light metal hydrides, are found to be highly porous matrices such as silica aerogels, silica xerogels, carbon aerogels, carbon xerogels, carbon or meso-structured carbons (CMK-1, -2, -3, -4, -5), or other kinds of porous matrices, such as zeolites and porous metal organic frame works (as, for instance, described by Yaghi), metal form, porous polymer, etc., if they are fixed.

Encapsulation in general, as exemplified by the metal hydrides for hydrogen storage materials, leads to high dispersion of the material with the following three effects:
1. Kinetics is improved, since mass transfer distances are minimized;
2. Thermodynamics are altered, since large surface effects of nanosized powders can lead to additional energetic contribution, which in favorable cases leads to destabilization;
3. The incorporation leads to hindered access of air and moisture and thus to improved safety.

Components that are suitable for hydrogen storage purposes and that can be encapsulated are for example metal hydrides, preferably alanates, e. g. alkali alanate such as sodium alanate (NaAlH₄). Other useful materials for encapsulation are mixtures of aluminium metal with alkali metal or alkali metal hydride.

In a preferred embodiment of present invention the material further contains a catalyst selected form a transition metal, a rare earth metal, a transition metal compound or a rare earth metal compound. Preferably Ti is used as transition metal. A hydrogen storage material doped with a transition metal, rare earth metal or a compound thereof shows a higher desorption rate than the materials containing no catalyst.

As described in the present examples the encapsulation of Ti doped sodium alanate in porous carbon (specified by the data given in examples) is carried out by successively impregnating the porous carbon with solutions of the doping agent (TiCl₄) and NaAlH₄ in organic solvents, e. g. toluene, and subsequent removal of organic solvents in vacuum.

A further subject of present invention is a process for preparing of material comprising a component suitable for hydrogen storage purposes selected from alkali alanate, a mixture of aluminum metal with alkali metal and/or alkali metal hydride and magnesium hydride or mixtures thereof, comprising the steps of impregnating the porous matrix material with a solution and/or suspension of said components in an organic solvent and removing the organic solvent.

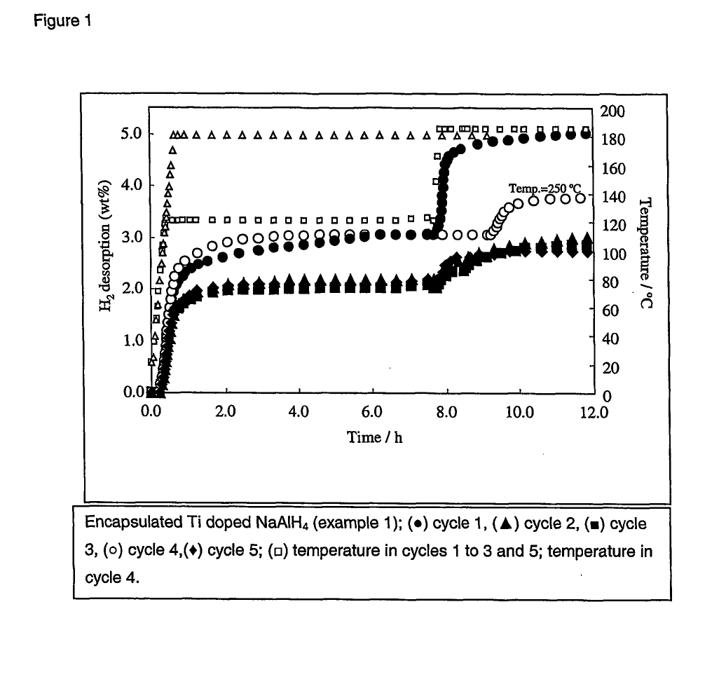

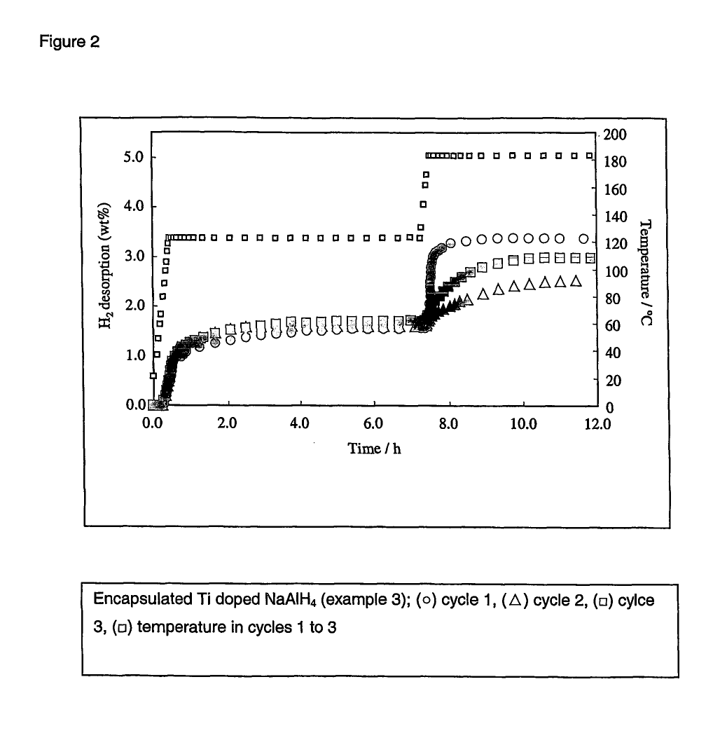

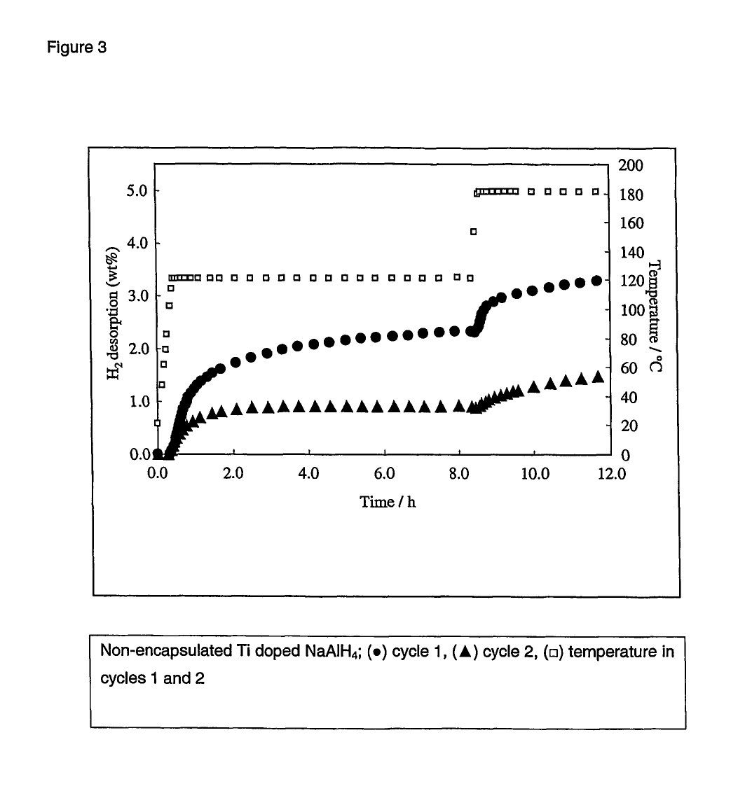

The encapsulated Ti doped NaAlH₄ shows the ability in cycle tests to be reversibly de- and recharged with hydrogen under the same conditions as the non-encapsulated Ti doped NaAlH₄ (Table 1). However, as it can be seen by comparison of FIGS. 1 and 2 with the FIG. 3, the encapsulated Ti doped NaAlH₄ reveals a higher hydrogen desorption rate than the non-encapsulated one. So, for examples, the encapsulated Ti doped NaAlH₄ (FIG. 1) at 120° C. is discharged to the extent of 80% in only 30-40 min, while the non-encapsulated Ti doped NaAlH₄ (FIG. 3) at the same temperature requires 2½ h to desorb 80% of stored hydrogen.

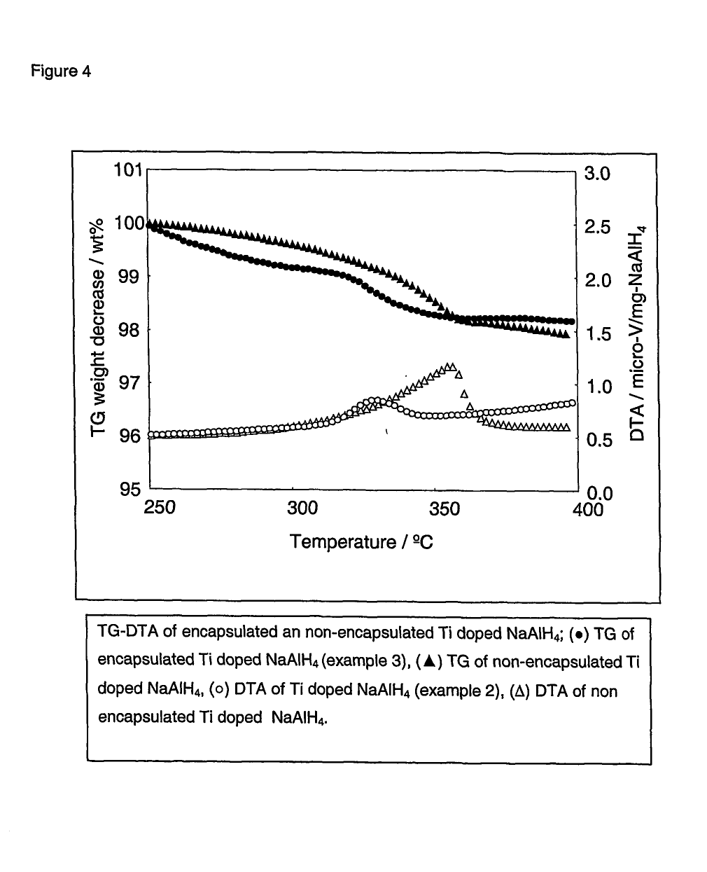

Decomposition of NaAlH₄ is in several steps. After NaH, Al and H₂ are generated, in the final step NaH is further decomposed to Na and H₂. Due to the higher dispersion of the materials thermodynamics are altered; the process is carried out at lower temperatures. (FIG. 4)

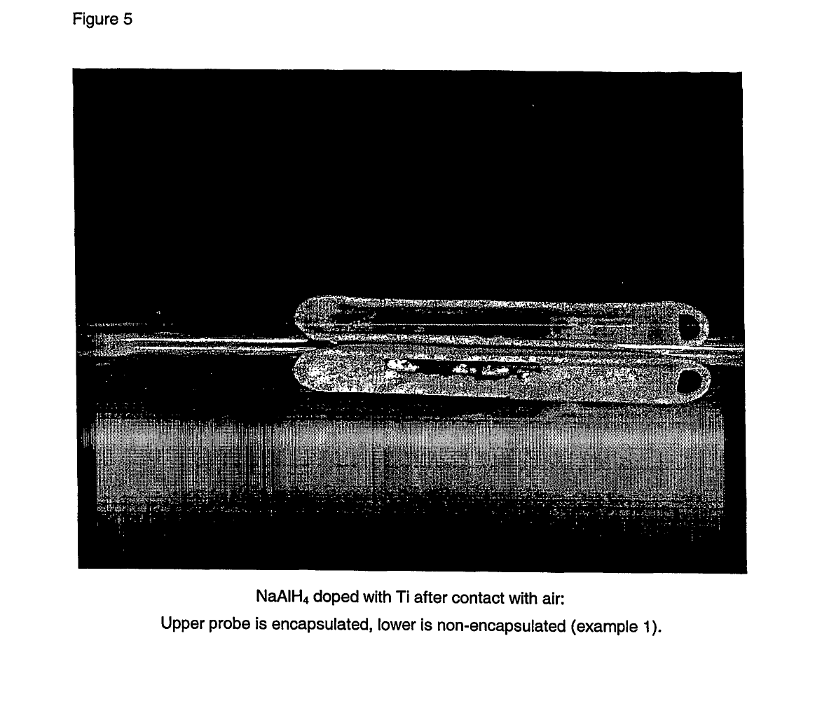

In addition, as shown in FIG. 5, in contrast to the non-encapsulated Ti doped NaAlH₄, the encapsulated Ti doped NaAlH₄ does not ignite in air.

A further subject of present invention is the use of the encapsulated materials of present invention, e. g. light metal hydrides encapsulated in highly porous matrices, as hydrogen storage materials, for instance for supplying fuel cell systems of fuel cell vehicles with hydrogen, with advantages described above.

For illustration of the invention serve the following examples.

### EXAMPLES

### Example 1

### Preparation of Porous Carbon

Porous carbon was prepared essentially following the recipe described in J. Non.-Cryst. Solids 1997, 221, 144. Accordingly, resorcinol (19.4 g) was copolymerized with formaldehyde in water (68 ml) in the presence of sodium carbonate as a base (molar ratio: 1:2:7:7·10⁻⁴). The solution was kept 24 h at room temperature, 24 h at 50° C. and finally 72 h at 90° C. The thus obtained aqueous gel was cut in pieces and suspended in acetone in order to exchange water in the pores against acetone. Every day in the course of 7 days the solution was decanted from the solid and fresh acetone was added. The obtained resorcinol-formaldehyde copolymer was evacuated, placed in quartz tube and then in argon stream, heated for 0.5 h to 350° C. and for 2.5 h to 1000° C. After cooling down to room temperature, the porous carbon was ground to a powder in an agate mortar. The thus obtained porous carbon (5.16 g), according to nitrogen sorption measurements, had a pore volume of 0.55 cm³/g, pore diameter of 22.6 nm and a surface area of 553.9 m³/g.

### Example 2

### Preparation of Ti-Doped NaAlH₄ Encapsulated in Porous Carbon

2.2885 g of porous carbon was evacuated for 3 h at 500° C. After cooling down to room temperature, porous carbon was impregnated with a TiCl₄/toluene (1/10, v/v) solution using the incipient wetness method and then the solvent removed by evacuation in vacuum. The weight of the sample increased to 2.6999 g, corresponding to 0.4114 g of supported TiCl₄. Subsequently the sample was impregnated in the same way with a 2 M solution of NaAlH₄ in tetrahydrofurane. The weight of the sample increased to 4.4489 g indicating 1.7490 g of supported NaAlH₄. As known, TiCl₄ reacts with NaAlH₄ under reduction to elemental titanium according to the following reaction;
TiCl₄+4NaAlH₄→Ti+4NaCl+4Al+8H₂↑

Accordingly, the composition of the Ti doped NaAlH₄ encapsulated in porous carbon is: porous carbon, 2.2885 g; Ti, 0.1039 g; NaAlH₄, 1.280 g; NaCl, 0.5069 g. This composition corresponds to the NaAlH₄ loading level of 30.6 wt % and to doping level of Ti in NaAlH₄ of 8.3 mole %. Assuming the density of NaAlH₄ were 1.28 g/cm³ and of NaCl 2.20 g/cm³, the pore occupancy of the carbon matrix of 98% was calculated.

### Example 3

Preparation of porous carbon was carried out in the same way as in Example 1, except that the amount of Na₂CO₃ was doubled. Properties of the porous carbon of the Example 3, according to nitrogen sorption measurements: pore volume 0.98 cm³/g, pore diameter 15.3 nm, surface area 578.2 m²/g. According to the composition of encapsulated Ti doped NaAlH₄, the loading level of NaAlH₄ in the matrix was 48.9 wt % and the doping level of Ti in NaAlH₄ 3.9 mole %. On the basis of the assumed NaAlH₄ and NaCl densities, a pore occupancy of 104% was calculated.

Hydrogen de- and reabsorption measurements of Ti doped NaAlH₄ encapsulated in porous carbon: Hydrogen desorptions were measured by heating in a thermovolumetric apparatus 1-1.2 g sample successively to 120 and 180° C. (4° C./min) and keeping temperature at the two levels constant until the end of hydrogen desorption. Hydrogen reabsorptions were carried out at 100° C./100 bar for 24 h in an autoclave.

TG-DTA measurements were perfomed under Ar flow (100 mL/min) with the temperature ramp rate of 2° C./min. for encapsulated Ti doped NaAlH₄ (Example 3) or for 4° C./min. for non-encapsulated Ti doped NaAlH₄. (FIG. 4)

Hydrogen storage capacities achieved in cycle tests (hydrogen de- and reabsorption measurements) of the Examples 1 and 2 are given in Table 1, and the hydrogen desorption curves illustrated by FIGS. 1 and 2. For comparison, a cycle test (Table 1 and FIG. 3) under the same conditions was carried out also with a sample of non-encapsulated Ti doped NaAlH₄, prepared by doping of NaAlH₄ with TiCl₄ in toluene, as described in J. Alloys Comp. 2000, 302, 36.

TABLE 1
Hydrogen storage capacities of encapsulated versus
non-encapsulated Ti doped NaAlH₄ (in the Examples 1 and 2,
wt % of hydrogen are normalized to NaAlH₄ only^{a)})

| | | | | | Non encapsulated | |
|---|---|---|---|---|---|---|
| | Example 1 | | Example 2 | | Ti doped NaAl H₄ | |
| | | total | | total | | total |
| Cycle | | capacity | | capacity | | capacity |
| number | 120° C. | (180° C.) | 120° C. | (180° C.) | 120° C. | (180° C.) |
| 1 | 3.06(0.88) | 5.16(1.48) | | | 2.32 | 3.70 |
| 2 | 2.17(0.62) | 3.16(0.91) | 1.55(0.60) | 3.36(1.31) | 0.90 | 1.58 |
| 3 | 2.03(0.58) | 2.86(0.82) | 1.59(0.62) | 2.53(0.98) | | |
| 4 | — | 3.04(0.88) | 1.70(0.66) | 2.97(1.16) | | |
| 5 | 2.11(0.61) | 3.12(0.90) | | | | |

^{a)}The values given in parenthesis are in terms of wt % H₂ with respect to overall weight of samples.

In the following examples the properties of the inventive material are shown, in particular the suppression of pyrophoric nature and the improvement of dehydrogenation kinetics.

Rehydrogenation Kinetics of PC Encapsulated Ti-NaAlH4

(Experimental procedure) Ti-NaAlH₄/PC in autoclave equipped with pressure sensor was heated to 100° C. in advance. 100 bar of hydrogen was introduced to this autoclave, and immediately disconnected from the hydrogen tank. Pressure drop caused by the rehydrogenation reaction was monitored automatically with a pressure sensor.

Preparation of Carbon Aerogel (I)

(A-01) Carbon aerogel was prepared following the recipe described in (R. W. Pekala, Mater. Res. Soc. Symp. Proc., 1990, 171, 285.; R. W. Pekala and C. T. Alviso, Mat. Res. Soc. Symp. Prc. 1992, 270, 3.; R. W. Pekala and D. W. Schaefer, Macromolecules 1993, 26, 5487.). Resorcinol (6.47 g) was copolymerized with formaldehyde in water (36.5%, 8.87 mL) in the presence of sodium carbonate as a base (resorcinol:formaldehyde:sodium carbonate:H₂O, 6.47 g:3.52 g:0.00890 g:33.86 g, molar ratio: 1.0:0.5:1.43×10⁻³:32.0). The mixed solution was kept 24 h at room temperature, 24 h at 50° C. and finally 72 h at 90° C. The obtained aqueous gel was cut in pieces and suspended in acetone in order to exchange water in the pore against acetone. Every day in the course of 7 days the solution was decanted from the solid and fresh acetone was added.

The acetone-filled gels were then placed in a jacketed pressure vessel which was subsequently filled with liquid carbon dioxide at 10° C. The copolymerized gels were exchanged with fresh carbon dioxide until the acetone was completely flushed from the system. At no time was the liquid CO₂ level allowed to drop below the top of the RF gels. The vessel was taken above the critical point of carbon dioxide (Tc=31° C. and Pc=7.4 MPa) and held at 47° C. and ˜100 bar for a minimum of 4 hours. While maintaining the temperature, the pressure was slowly released from the vessel overnight. At atmospheric pressure, the aerogel was removed form the vessel.

The obtained resorcinol-formaldehyde copolymer gel was placed in a quartz tube and then heated for 4 h to 1050° C. under an argon stream to obtain the carbon aerogel. The obtained carbon aerogel had a pore volume of 0.53 cm³/g, averaged pore diameter of 8.2 nm, and a surface area of 624.8 m²/g, according to nitrogen sorption measurements.

Preparation of Ti-Doped NaAlH₄ Encapsulated in Carbon Aerogel (I) by Melting Method—Sample A

(A-02) 3.02 g of NaAlH₄ and 0.340 g of TiCl₃ were mixed and ball-milled for 3 h to obtained Ti-doped NaAlH₄ (G. Sandrock et al. J. Alloys Compd. 339, 2002, 299. B. Bogdanović, Adv. Mater. 2003, 15, 1012.).

(A-03) 0.0848 g of carbon aerogel was evacuated for 3 h at 500° C. After cooling down to room temperature, carbon aerogel was physically mixed with Ti-doped NaAlH₄ (0.150 g). The mixture was then loaded into a glass vial in an autoclave, and then 140 bar of hydrogen was introduced in the autoclave. The autoclave was statically heated to 190° C. for 48 h (hydrogen pressure rose to 190 bar).

The obtained encapsulated sample shows the nitrogen sorption properties as follows; pore volume of 0.15 cm³/g, averaged pore diameter of 6.7 nm, and a surface area of 104.4 m²/g.

Decomposition of NaAlH₄ under Microwave Irradiation Sample A

(A-04) ca.0.05 g of Sample A was put in microwave oven, and treated at 600 W for 10 min. The XRD pattern after irradiation shows the diffraction signals of NaH and metal Al.

(A-05) As a comparison, ca. 0.05 g of Ti-doped NaAlH₄ (TAG-TA-403-02) was treated under same conditions. The diffraction signals are assignable NaAlH₄, and small amounts of Na₃AlH₆ were observed.

Preparation of Carbon Aerogel (II)

(A-06) Preparation of carbon aerogel (II) was carried out in the same way as in carbon aerogel (I), except that the amount of Na₂CO₃ was increased (resorcinol:formaldehyde:sodium carbonate:H₂O, 6.47 g:3.52 g:0.0.0208 g:33.86 g, molar ratio: 1.0:0.5:3.34×10⁻³: 32.0). Nitrogen sorption properties of the obtained carbon aerogel were 2.029 cm³/g, 15.55 nm, 731.6 m²/g.

Preparation of Ti-Doped NaAlH₄ Encapsulated in Carbon Aerogel (II) by Melting Method—Sample B

(B-01) 0.300 g of carbon aerogel was evacuated for 3 h at 500° C. After cooling down to room temperature, carbon aerogel was physically mixed with Ti-doped NaAlH₄ prepared according to TAG-TA-403-02 (0.200 g). The mixture was then loaded into a glass vial in an autoclave, and then 140 bar of hydrogen was introduced in the autoclave. The autoclave was statically heated to 190° C. for 50 h (hydrogen pressure rose to 190 bar). The obtained encapsulated sample had a pore volume of 1.034 cm³/g, pore diameter of 15.0 nm, and a surface area of 253.7 m²/g, according to nitrogen sorption measurements.

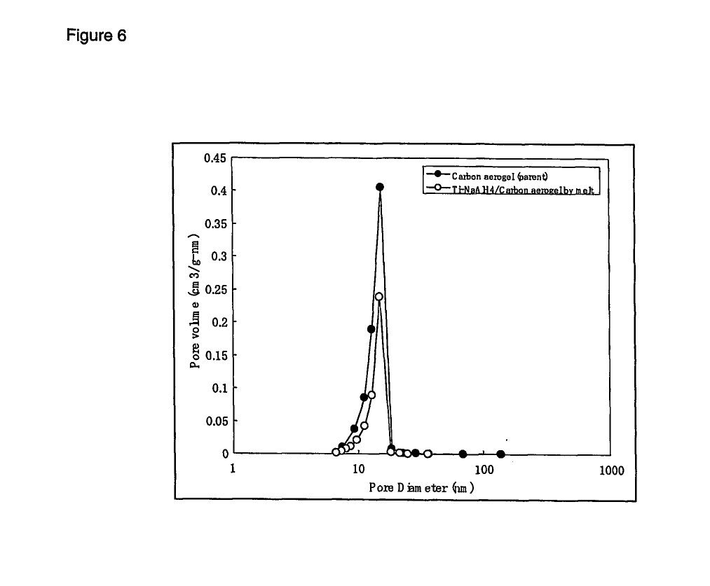

The pore size distribution of A-06 and B-01 are shown in FIG. 6.

1. Material comprising a hydrogen storage component selected from alkali alanate, a mixture of aluminum metal with alkali metal and/or alkali metal hydride and magnesium hydride and mixtures thereof, wherein the hydrogen storage component is encapsulated in a porous matrix.

2. Material according to claim 1, wherein said porous matrix is selected from solid inorganic materials.

3. Material according to claim 1, wherein said porous matrix comprises porous metal organic frameworks.

4. Material according to claim 1, wherein the hydrogen storage component comprises a transition metal, transition metal compound, rear-earth metal and/or rear-earth metal compound.

5. Process for preparing a material comprising a hydrogen storage component selected from alkali alanate, a mixture of aluminum metal with alkali metal and/or alkali metal hydride and magnesium hydride and mixtures thereof, comprising the steps of impregnating a porous matrix material with a solution and/or suspension of said hydrogen storage components in an organic solvent and removing the organic solvent.

6. (canceled)

7. A vehicle comprising a fuel cell system supplied with hydrogen from a material according to claim 1.

8. Material according to claim 1, wherein said solid inorganic materials are selected from the group consisting of porous carbon, mesostructured carbon, carbon xerogel, carbon aerogel, silica aerogel, silica xerogel, and zeolite.

9. A method of storing and eleasing hydrogen, comprising:
a) providing a material according to claim 1; and
b) storing and releasing hydrogen from material.
